(19) United States
(12) Patent Application Publication
(10) Pub. No.: US 2005/0168429 A1
(43) Pub. Date: Aug. 4, 2005

(54) [FLAT PANEL DISPLAY AND SOURCE DRIVER THEREOF]

(76) Inventor: Chun-Yi Chou, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/709,848

(22) Filed: Jun. 2, 2004

(30) Foreign Application Priority Data
Feb. 3, 2004 (TW) 93102360

(51) Int. Cl. G09G 3/36

(52) U.S. Cl. 345/100

(57) ABSTRACT

A source driver is provided. The source driver receives a clock signal, a display data, and a control signal to drive a display panel. The source driver comprises: a receiver for receiving the clock signal, the display data, and the control signal; and a transmitter, coupled to the receiver, for enhancing a driving ability of the clock signal, the display data, and the control signal and outputting the enhanced clock signal, the enhanced display data, and the enhanced control signal for use of another source driver in a next stage.

### CROSS REFERENCE TO RELATED APPLICATIONS

This application claims the priority benefit of Taiwan application serial no. 93102360, filed on Feb. 03, 2004

### BACKGROUND OF INVENTION

1. Field of the Invention

This invention generally relates to a flat panel display, and more particularly to a source driver of a flat panel display.

2. Description of Related Art

A flat panel display (FPD) has the advantages of light weight, thin and compact size, and low power consumption. Hence it can occupy less space than traditional displays. Among several flat panel displays, the liquid crystal display (LCD) has the best chance to replace the traditional CRT monitors. To make more consumers replace traditional CRT monitors with LCD and enhance its competitives, it is unavoidable to reduce its manufacture cost.

FIG. 1 is a block diagram of a conventional LCD. Referring to FIG. 1, the LCD panel 110 includes a plurality of gate channels 121 and source channels 131. The crossing of each gate channel and source channel has a pixel (not shown). The pixel status depends on the source channel signal 131 during the period that the gate channel signal 121 is on. The gate channel signals 121 are generated by he gate driver 120 based on the gate control signal G_CONT. The source signals 131 are generated by the source driver 130 based on the clock signal CLK, display data DATA, and source control signal CONT. The gate control signal G_CONT, the clock signal CLK, the display data DATA, and the source control signal CONT are provided by the timing controller 140.

To further describe the conventional source driver, a portion of the source driver of FIG. 1 is shown in FIGS. 1A and 1B. FIG. 1A shows a block diagram that a portion of the source driver is applied to a low-resistance circuit (e.g., FPC). Referring to FIG. 1A, due to the cost and the design flexibility, generally the source driver 130 will be implemented by combining several ICs (such as the source drivers 130_1-130_n in FIG. 1A). Each IC provides a portion of the source channel signals 131. Each source driver IC generally is disposed on a flexible printer circuit board (FPC) so that the buses (CLK, DATA, CONT and other buses) between the timing controller 140 and the source drivers 130_1-130_n can transmits signals with a lower resistance.

However, the assembly cost for the FPC technology is too high to be acceptable and the yield rate is difficult to enhance. Hence, the number of the FPC has to be reduced. Hence, the conventional art disposes the source driver ICs on the LCD panel, and use ITO (indium tin oxide) to implement the circuit between the timing controller and the source drivers. FIG. 1B shows a block diagram that a portion of the source driver is applied to a high-resistance circuit (e.g., ITO). Referring to FIG. 1B, because ITO has a high resistance signal path, the equivalent resistors in FIG. 1B represent the resistance of the ITO signal paths. Therefore, the farther the source drivers 130_1-130_n are away from the timing controller 140, the larger the resistance between the source drivers 130_1-130_n and the timing controller 140. I.e., the higher resistance will reduce the max operation frequency of the system.

### SUMMARY OF INVENTION

An object of the present invention is to provide a source driver suitable for a high resistance signal path (such as the ITO path in the LCD panel) in order to reduce the number of the FPC for connecting the timing controller and the LCD panel, and therefore to reduce the production cost. Further, the source driver of the present invention provides a transmitter to enhance the signal driving ability so as to overcome the high resistance of the signal path and increase the max operation frequency.

Another object of the present invention is to provide a flat panel display by series-connecting the source drivers of the present invention so that the source driver in each stage enhances the signal driving ability and then sends it to the source driver in the next stage. Therefore, it can be used in a high resistance signal path (such as the ITO path in the LCD panel) in order to reduce the number of the FPC for connecting the timing controller and the LCD panel without sacrificing the performance, and therefore to reduce the production cost and increase the yield rate.

Still another object of the present invention is to provide a source driver with options for setting the operation mode in a master mode or a slave mode in order to reduce power consumption.

Still another object of the present invention is to provide the flat panel display that can set and adjust the source drive in each stage to be in a master mode or a slave mode based on the path resistance and the tolerance of the system delay time, in order to reduce the power consumption and the EMI.

The present invention provides a source driver, receiving a clock signal, a display data, and a control signal to drive a display panel, comprising: a receiver for receiving the clock signal, the display data, and the control signal; and a transmitter, coupled to the receiver, for enhancing a driving ability of the clock signal, the display data, and the control signal and outputting the enhanced clock signal, the enhanced display data, and the enhanced control signal for use of another source driver in a next stage.

In a preferred embodiment of the present invention, the transmitter/receiver is a differential signal transmitter/receiver, or a TTL signal transmitter/receiver. The transmitter can also be a voltage mode signal transmitter or a current mode signal transmitter.

In a preferred embodiment of the present invention, the transmitter includes: a data synchronization circuit synchronizing the clock signal, the display data, and the control signal received from the receiver; and a plurality of buffers, coupled to the data synchronization circuit, receiving the synchronized clock signal, the synchronized display data, and the synchronized control signal, enhancing the driving ability of the synchronized clock signal, the synchronized display data, and the synchronized control signal, and outputting the enhanced clock signal, the enhanced display data, and the enhanced control signal for use of the another source driver in the next stage.

In a preferred embodiment of the present invention, the transmitter includes a plurality of voltage buffers receiving the clock signal, the display data, and the control signal, enhancing the driving ability of the clock signal, the display data, and the control signal, and outputting the enhanced clock signal, the enhanced display data, and the enhanced control signal for use of the another source driver in the next stage.

The present invention provides a flat panel display, comprising: a display panel; a timing controller outputting a clock signal, a display data, and a control signal; and a plurality of source drivers, the plurality of source drivers being series-connected to be a series structure, the plurality of source drivers being coupled to the display panel, one end of the series structure being coupled to the timing controller, the plurality of source drivers receiving the clock signal, the display data, and the control signal to drive the display panel, enhancing a driving ability of the clock signal, the display data, and the control signal, and outputting the enhanced clock signal, the enhanced display data, and the enhanced control signal for use of another source driver in a next stage.

In a preferred embodiment of the present invention, each of the plurality of source drivers, comprises: a receiver for receiving the clock signal, the display data, and the control signal; and a transmitter, coupled to the receiver, for enhancing the driving ability of the clock signal, the display data, and the control signal and outputting the enhanced clock signal, the enhanced display data, and the enhanced control signal for use of the another source driver in the next stage.

In a preferred embodiment of the present invention, the transmitter includes: a data synchronization circuit synchronizing the clock signal, the display data, and the control signal received from the receiver; and a plurality of buffers, coupled to the data synchronization circuit, receiving the synchronized clock signal, the synchronized display data, and the synchronized control signal, enhancing the driving ability of the synchronized clock signal, the synchronized display data, and the synchronized control signal, and outputting the enhanced clock signal, the enhanced display data, and the enhanced control signal for use of the another source driver in the next stage.

In a preferred embodiment of the present invention, the transmitter includes a plurality of voltage buffers receiving the clock signal, the display data, and the control signal, enhancing the driving ability of the clock signal, the display data, and the control signal, and outputting the enhanced clock signal, the enhanced display data, and the enhanced control signal for use of the another source driver in the next stage.

In a preferred embodiment of the present invention, the display panel is a α-Si liquid crystal display panel or a low temperature poly-silicon liquid crystal display panel.

The present invention provides a source driver, receiving a master/slave setting signal, a clock signal, a display data, and a control signal to drive a display panel, comprising: a receiver for receiving the clock signal, the display data, and the control signal; and a transmitter, coupled to the receiver, transmitter receiving the master/slave setting signal, the transmitter responsive to the master/slave setting signal operating in one of a master mode and a slave mode; wherein when the transmitter operates in the master mode, the transmitter enhances a driving ability of the clock signal, the display data, and the control signal and outputs the enhanced clock signal, the enhanced display data, and the enhanced control signal for use of another source driver in a next stage; when the transmitter operates in the slave mode, the transmitter directly outputs the clock signal, the display data, and the control signal received from the receiver for use of the another source driver in the next stage.

In a preferred embodiment of the present invention, the transmitter/receiver is a differential signal transmitter/receiver, or a TTL signal transmitter/receiver. The transmitter can also be a voltage mode signal transmitter or a current mode signal transmitter.

The transmitter includes: a data synchronization circuit synchronizing the clock signal, the display data, and the control signal received from the receiver; and a plurality of buffers, coupled to the data synchronization circuit, receiving the synchronized clock signal, the synchronized display data, and the synchronized control signal, enhancing the driving ability of the synchronized clock signal, the synchronized display data, and the synchronized control signal, and outputting the enhanced clock signal, the enhanced display data, and the enhanced control signal for use of the another source driver in the next stage.

In a preferred embodiment of the present invention, the transmitter includes a plurality of voltage buffers receiving the clock signal, the display data, and the control signal, enhancing the driving ability of the clock signal, the display data, and the control signal, and outputting the enhanced clock signal, the enhanced display data, and the enhanced control signal for use of the another source driver in the next stage.

The present invention provides A flat panel display, comprising: a display panel; a timing controller outputting a clock signal, a display data, and a control signal; a control circuit outputting a plurality of mater/slave setting signals; and a plurality of source drivers, the plurality of source drivers being series-connected to be a series structure, the plurality of source drivers being coupled to the display panel, one end of the series structure being coupled to the timing controller, the plurality of source drivers receiving the clock signal, the display data, and the control signal to drive the display panel, each of the plurality of source drivers responsive to a corresponding one of the plurality of mater/slave setting signals determining whether to enhancing a driving ability of the clock signal, the display data, and the control signal, andoutputting the enhanced clock signal, the enhanced display data, and the enhanced control signal for use of another source driver in a next stage.

In a preferred embodiment of the present invention, each of the plurality of source drivers, comprises: a receiver for receiving the clock signal, the display data, and the control signal; and a transmitter, coupled to the receiver, transmitter receiving the master/slave setting signal, the transmitter responsive to the master/slave setting signal operating in one of a master mode and a slave mode; wherein when the transmitter operates in the mater mode, the transmitter enhances the driving ability of the clock signal, the display data, and the control signal and outputs the enhanced clock signal, the enhanced display data, and the enhanced control signal for use of the another source driver in the next stage; when the transmitter operates in the slave mode, the transmitter directly outputs the clock signal, the display data, and the control signal received from the receiver for use of the another source driver in the next stage.

In a preferred embodiment of the present invention, the display panel is aα-Si liquid crystal display panel or a low temperature poly-silicon liquid crystal display panel.

The present invention utilizes the series connection structure to couple the source drivers and enhances the driving ability of the received clock signal, display data, and the control signal. Hence, the present invention can be applied to a high resistance path (such as the ITO path in the LCD panel) in order to reduce the number of the FPC for connecting the timing controller and the LCD panel without sacrificing the performance so as to overcome the high resistance of the signal path and increase the max operation frequency. Therefore, the present invention can reduce the production cost and increase the yield rate.

The present invention further provides the option to set the source driver in a master mode or a slave mode based on the path resistance and the tolerance of the system delay time, in order to reduce the power consumption and the EMI.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of a conventional LCD.

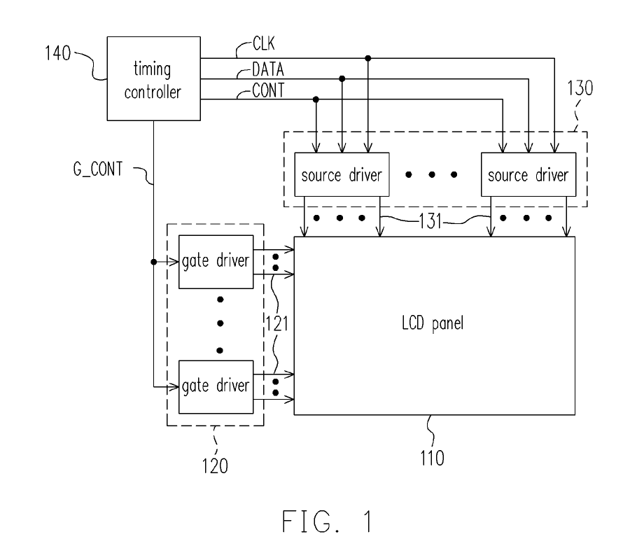

FIG. 1A shows a block diagram that a portion of the source driver in FIG. 1 is applied to a low-resistance circuit (e.g., FPC).

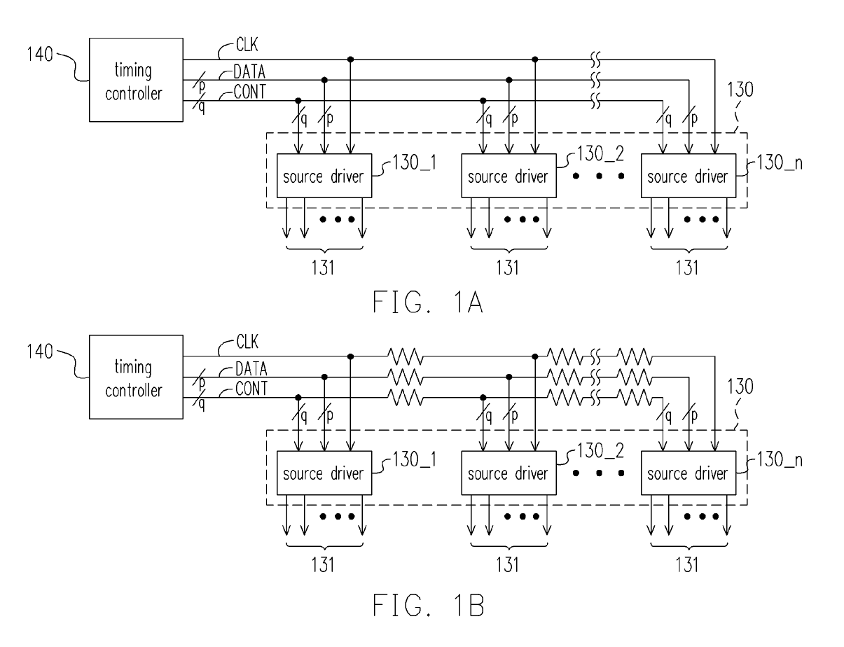

FIG. 1B shows a block diagram that a portion of the source driver in FIG. 1 is applied to a high-resistance circuit (e.g., ITO).

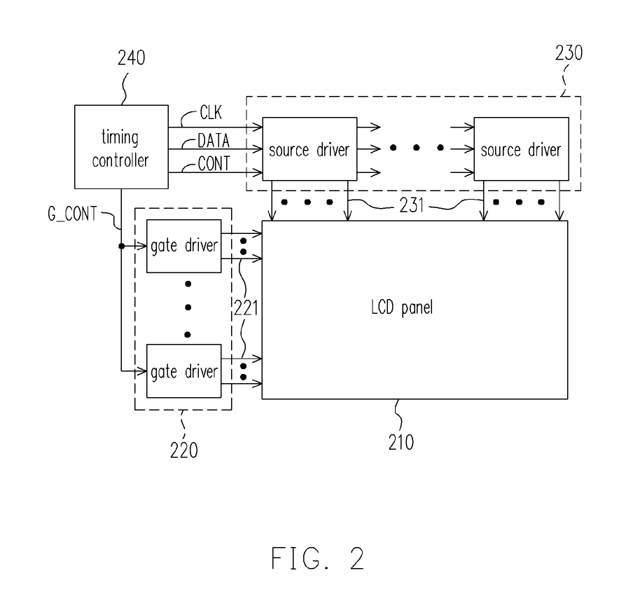

FIG. 2 is a block diagram of a LCD in accordance with a preferred embodiment of the present invention.

FIG. 2A shows a block diagram of a portion of the source driver in FIG. 2 FIG. 2B is a block diagram of a source driver in FIG. 2 in accordance with a preferred embodiment of the present invention.

FIG. 2C is a timing sequence of the after-synchronized input data of the source driver of FIG. 2B.

FIG. 2D is another block diagram of a source driver in FIG. 2 in accordance with a preferred embodiment of the present invention.

FIG. 3A a block diagram of a display source drive circuit in accordance with another preferred embodiment of the present invention.

FIG. 3B a block diagram of a source driver (in a slave mode) in accordance with another preferred embodiment of the present invention.

FIG. 3C a block diagram of a source driver (in a master mode) in accordance with another preferred embodiment of the present invention.

FIG. 3D a block diagram of another source driver (in a master mode) in accordance with another preferred embodiment of the present invention.

### DETAILED DESCRIPTION

To facilitating illustration of the present invention, the following embodiments use LCD as an example. It should be noted that the present invention is not limited to LCD.

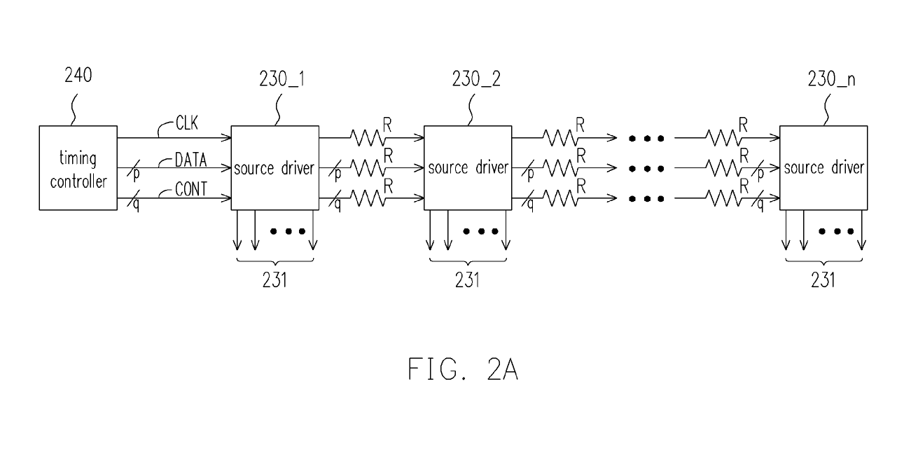

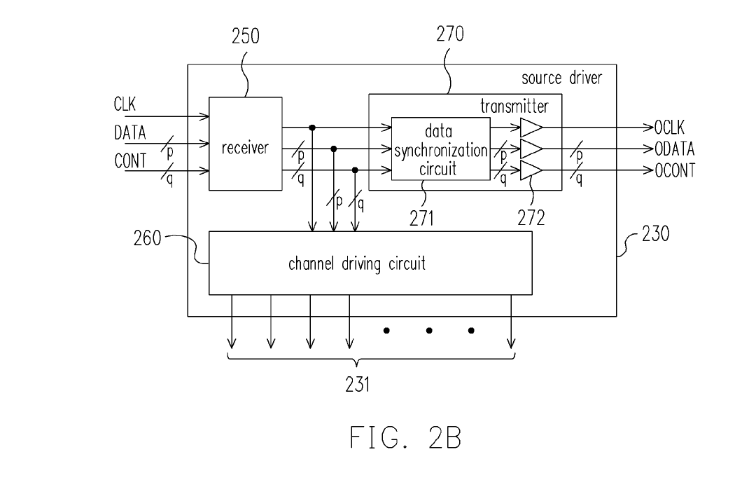

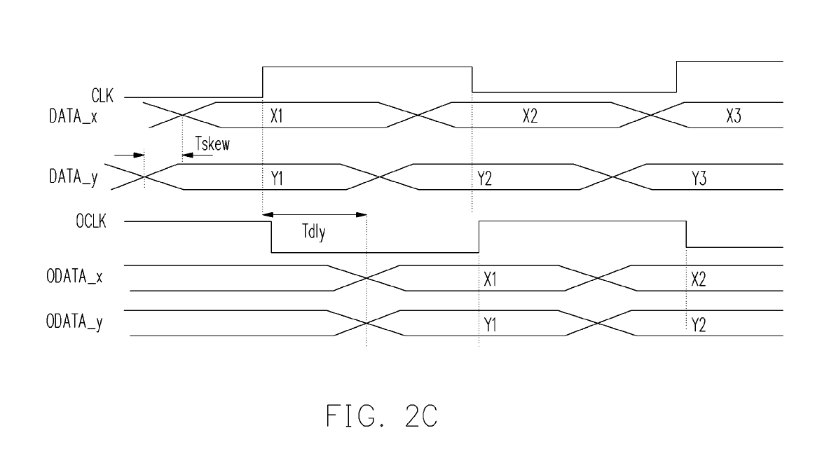

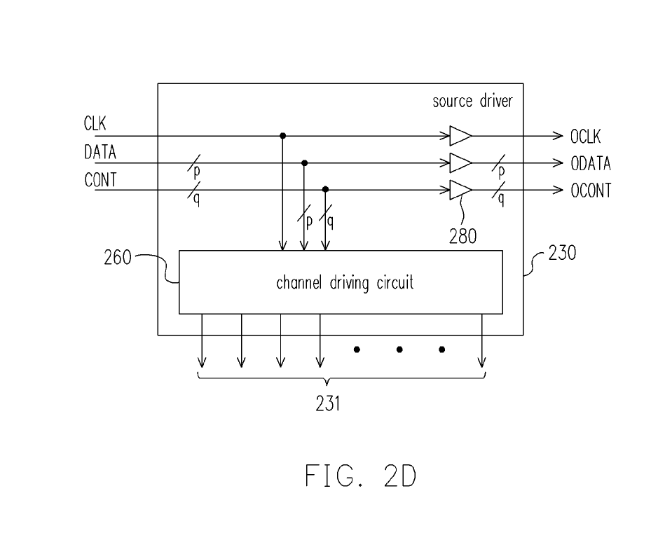

FIG. 2 is a block diagram of a LCD in accordance with a preferred embodiment of the present invention. Referring to FIG. 2, there are a plurality of gate channels 221 and source channels 231 cross-disposed on the LCD panel 210. The crossing of each gate channel and source channel has a pixel (not shown). The pixel status depends on the source channel signal 231 during the period that the gate channel signal 221 is on. The gate channel signals 221 are generated by the gate driver 220 based on the gate control signal G_CONT. The source signals 231 are generated by the source driver 230 based on the clock signal CLK, display data DATA, and source control signal CONT. The gate control signal G_CONT, the clock signal CLK, the display data DATA, and the source control signal CONT are provided by the timing controller 240.

To further describe the source driver in accordance of a preferred embodiment, a portion of the source driver of FIG. 2 is shown in FIG. 2A. FIG. 2A shows a block diagram of a portion of the source driver in FIG. 2. Referring to FIG. 2A, the source drivers 230_1-230_n are series-connected to be a series structure. One end of the series structure (in this embodiment it is the source driver 230_1) is coupled to the timing controller 240. The source drivers 230_1-230_n respectively provide a portion of the source channel signal 231. The equivalent resistor R in FIG. 2A represents the resistance of the signal path such as the ITO path on the display panel. The source drivers receive the clock signal CLK, the display data DATA, and the control signal CONT to drive the display panel (such as the LCD panel 210 in FIG. 2), enhance the driving ability of the clock signal CLK, the display data DATA, and the control signal CONT, and then output those signals for the use of the source driver in the next stage.

The source driver in the above embodiment can be implemented as shown in FIG. 2B. FIG. 2B is a block diagram of a source driver in FIG. 2 in accordance with a preferred embodiment of the present invention. Referring to FIG. 2B, the receiver 250 of the source driver 230 receives the clock signal CLK, the display data DATA, and the control signal CONT from the timing controller 240 or the source driver in the previous stage. The channel driving circuit 260 obtains the clock signal CLK, the display data DATA, and the control signal CONT from the receiver 250 and based on those signals generates a plurality of source channel signals 231. Each source channel signal 231 will drive the corresponding source channel. The receiver 250 and the channel driving circuit 260 can be implemented by prior art and is not necessary to describe it here.

The transmitter 270 in this embodiment includes the data synchronization circuit 271 and the buffers 272. The data synchronization circuit 271 receives a plurality of signals, synchronizes those signals, and outputs the synchronized signals. In this embodiment, for example, the clock signal CLK can be used as a base for synchronizing the other signals. The buffers 272 respectively receive the clock signal CLK, the display data DATA, and the control signal CONT, enhance their driving ability, and then output those enhanced clock signal OCLK, the display data ODATA, and the control signal OCONT.

FIG. 2C is a timing sequence of the after-synchronized input data of the source driver of FIG. 2B. Referring to FIGS. 2B and 2C, assuming that the display data DATA has two data lines DATA_x and DATA_y, because the equivalent resistance and the stray capacitance of the signal transmission paths for data lines DATA_x and DATA_y is different, the transmission delay will be different. As shown in FIG. 2C, the data lines DATA_x and DATA_y will have a path delay Tskew. After through the data synchronization circuit 271 and the buffers 272, the path delay Tskew between the signals will be compensated. Hence, the transmission delay will not accumulated. As shown in FIG. 2C, the data ODATA_x and ODATA_y will be sent out at the same time for the use of the source driver in the next stage.

In this embodiment, the signals transmitted between the source drivers for example are voltage mode differential signals, current mode differential signals, TTL signals, or other types of signals.

The source driver in the above embodiment can be implemented as shown in FIG. 2D. FIG. 2D is another block diagram of a source driver in FIG. 2 in accordance with a preferred embodiment of the present invention. Referring to FIG. 2D, the receiver and the transmitter can be implemented by a plurality of voltage buffers 280. The source driver 230 receives the clock signal CLK, the display data DATA, and the control signal CONT from the timing controller 240 or the source driver in the previous stage. The channel driving circuit 260 obtains the clock signal CLK, the display data DATA, and the control signal CONT and based on those signals generates a plurality of source channel signals 231. Each source channel signal 231 will drive the corresponding source channel. The voltage buffers 280 respectively receive the clock signal CLK, the display data DATA, and the control signal CONT, enhance their driving ability and then output those enhanced clock signal OCLK, the display data ODATA, and the control signal OCONT.

Hence, this embodiment can apply the source driver in a high resistance circuit such as ITO without sacrificing the performance. In addition, because the source driver is disposed on the display panel, it can reduce the number of the FPC and thus reduce the assembly cost of the flat panel display and enhance the yield rate.

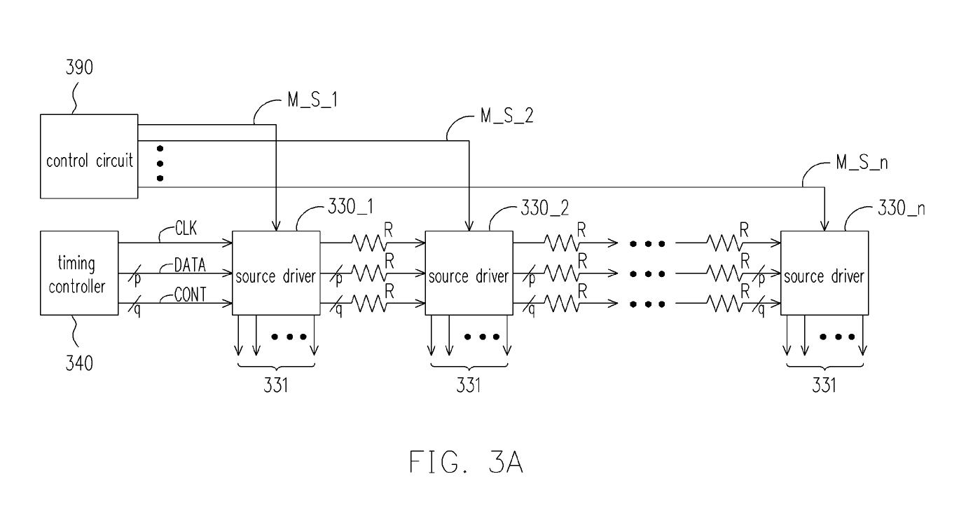

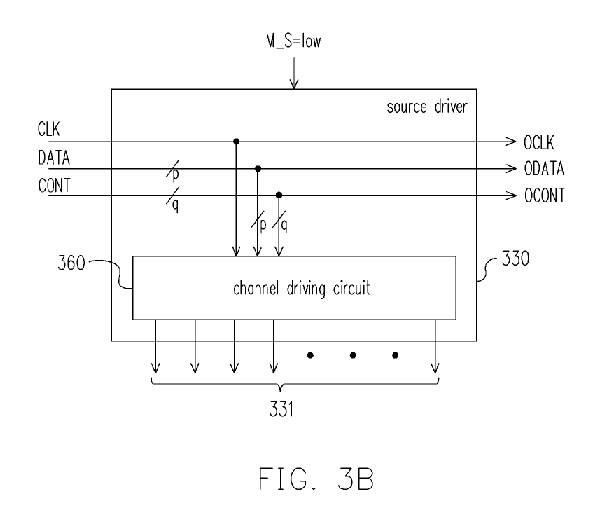

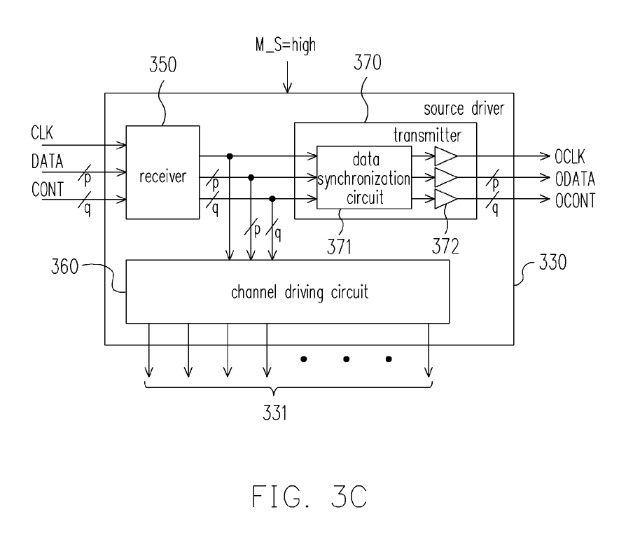

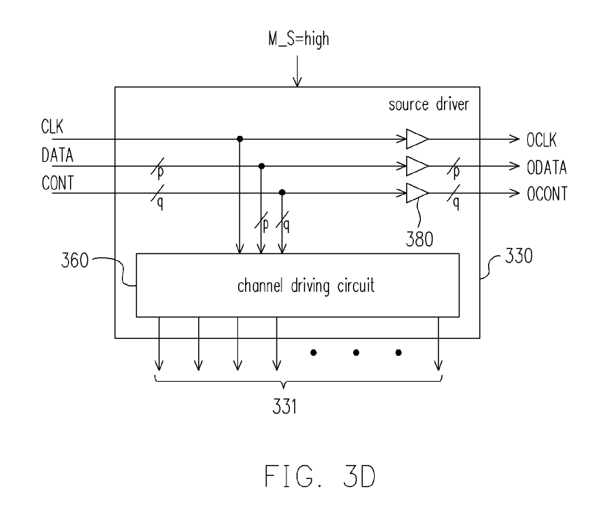

To reduce the power consumption, if the signal path delay is in an acceptable range, the present invention provides a bus structure which uses a transmitter to drive a plurality of source drivers. FIG. 3A a block diagram of a display source drive circuit in accordance with another preferred embodiment of the present invention. Referring to FIG. 3A, the source drivers 330_1-330_n are series-connected to be a series structure. One end of the series structure (in this embodiment it is the source driver 330_1) is coupled to the timing controller 340. The source drivers 330_1-330_n respectively provide a portion of the source channel signal 331. The equivalent resistor R in FIG. 3A represents the resistance of the signal path such as the ITO path on the display panel. The source drivers receive the clock signal CLK, the display data DATA, and the control signal CONT to drive the display panel (such as the LCD panel 210 in FIG. 2).

The source drivers 330_1-330_n respectively receive the master/slave setting signals M_S_1 M_S_n. The source drivers based on the master/slave setting signals operate in one of the master mode or the slave mode. When the source driver operates in the master mode, it will enhance the driving ability of the clock signal CLK, the display data DATA, and the control signal CONT, and then output those signals for the use of the source driver in the next stage. When the source driver operates in the slave mode, the source driver will directly output the clock signal CLK, the display data DATA, and the control signal CONT in order to reduce power consumption. The master/slave setting signals M_S_1 M_S_n are provided by the control circuit 390.

FIG. 3B a block diagram of a source driver (in a slave mode) in accordance with another preferred embodiment of the present invention. Referring to FIG. 3B, the source driver 330 receives the clock signal CLK, the display data DATA, and the control signal CONT from the timing controller 340 or the source driver in the previous stage. The channel driving circuit 360 obtains the clock signal CLK, the display data DATA, and the control signal CONT and based on those signals generates a plurality of source channel signals 331. Each source channel signal 331 will drive the corresponding source channel. The source driver 330 further receives the master/slave setting signal M_S. For example, when the master/slave setting signal M_S is low, the source driver 330 is set to operate in the slave mode; when the master/slave setting signal M_S is high, the source driver 330 is set to operate in the master mode. When the source driver operates in the slave mode, the source driver will directly output the clock signal CLK, the display data DATA, and the control signal CONT via the pass line.

When the master/slave setting signal M_S is high, the source driver 330 is set to operate in the master mode. FIG. 3C a block diagram of a source driver (in a master mode) in accordance with another preferred embodiment of the present invention. Referring to FIG. 3C, the source driver 330 includes a receiver 350 and a transmitter 370. In this embodiment, when the source driver 330 is set to operate in the master mode, the operation is similar to the previous embodiment shown in FIG. 2B and thus is not necessary to describe again.

FIG. 3D a block diagram of another source driver (in a master mode) in accordance with another preferred embodiment of the present invention. Referring to FIG. 3D, the receiver and the transmitter are implemented by a plurality of voltage buffers 380. The operation of the embodiment in FIG. 3D is similar to the previous embodiment shown in FIG. 2D and thus is not necessary to describe again.

In this embodiment, the operation mode of each source drivers flexibly depends on the range of the acceptable system time delay. Taking a LCD panel with ten source drivers as an example, the possible combination of the source drivers can be M-M-M-M-M-M-M-M-M-M, M-S-M-S-M-S-M-S-M-S, M-S-S-M-S-S-M-S-S-S, M-S-S-S-M-S-S-S-M-S, or M-S-S-S-S-M-S-S-S-S; wherein M represents that the source driver operates in the master mode and S represents that the source driver operates in the slave mode. The above combination of the source drivers can be adjusted based on the resistance of the signal path. Hence, this embodiment can further reduce the power consumption and EMI.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A source driver, receiving a clock signal, a display data, and a control signal to drive a display panel, comprising:
a receiver for receiving said clock signal, said display data, and said control signal; and
a transmitter, coupled to said receiver, for enhancing a driving ability of said clock signal, said display data, and said control signal and outputting said enhanced clock signal, said enhanced display data, and said enhanced control signal for use of another source driver in a next stage.

2. The source driver of claim 1, wherein said transmitter is a differential signal transmitter.

3. The source driver of claim 2, wherein said receiver is a differential signal receiver.

4. The source driver of claim 2, wherein said transmitter is a voltage mode differential signal transmitter.

5. The source driver of claim 2, wherein said transmitter is a current mode differential signal transmitter.

6. The source driver of claim 1, wherein said transmitter is a TTL signal transmitter.

7. The source driver of claim 6, wherein said receiver is a TTL signal receiver.

8. The source driver of claim 1, wherein said transmitter includes:
a data synchronization circuit synchronizing said clock signal, said display data, and said control signal received from said receiver; and
a plurality of buffers, coupled to said data synchronization circuit, receiving said synchronized clock signal, said synchronized display data, and said synchronized control signal, enhancing said driving ability of said synchronized clock signal, said synchronized display data, and said synchronized control signal, and outputting said enhanced clock signal, said enhanced display data, and said enhanced control signal for use of said another source driver in said next stage.

9. The source driver of claim 1, wherein said transmitter includes a plurality of voltage buffers receiving said clock signal, said display data, and said control signal, enhancing said driving ability of said clock signal, said display data, and said control signal, and outputting said enhanced clock signal, said enhanced display data, and said enhanced control signal for use of said another source driver in said next stage.

10. The source driver of claim 1, wherein said display panel is a α-Si liquid crystal display panel.

11. The source driver of claim 1, wherein said display panel is a low temperature poly-silicon liquid crystal display panel.

12. A flat panel display, comprising:
a display panel;
a timing controller outputting a clock signal, a display data, and a control signal; and
a plurality of source drivers, said plurality of source drivers being series-connected to be a series structure, said plurality of source drivers being coupled to said display panel, one end of said series structure being coupled to said timing controller, said plurality of source drivers receiving said clock signal, said display data, and said control signal to drive said display panel, enhancing a driving ability of said clock signal, said display data, and said control signal, and outputting said enhanced clock signal, said enhanced display data, and said enhanced control signal for use of another source driver in a next stage.

13. The flat panel display of claim 12, wherein each of said plurality of source drivers, comprises:
a receiver for receiving said clock signal, said display data, and said control signal; and
a transmitter, coupled to said receiver, for enhancing said driving ability of said clock signal, said display data, and said control signal and outputting said enhanced clock signal, said enhanced display data, and said enhanced control signal for use of said another source driver in said next stage.

14. The flat panel display of claim 13, wherein said transmitter is a differential signal transmitter.

15. The flat panel display of claim 14, wherein said receiver is a differential signal receiver.

16. The flat panel display of claim 14, wherein said transmitter is a voltage mode differential signal transmitter.

17. The flat panel display of claim 14, wherein said transmitter is a current mode differential signal transmitter.

18. The flat panel display of claim 13, wherein said transmitter is a TTL signal transmitter.

19. The flat panel display of claim 18, wherein said receiver is a TTL signal receiver.

20. The flat panel display of claim 13, wherein said transmitter includes:
a data synchronization circuit synchronizing said clock signal, said display data, and said control signal received from said receiver; and
a plurality of buffers, coupled to said data synchronization circuit, receiving said synchronized clock signal, said synchronized display data, and said synchronized control signal, enhancing said driving ability of said synchronized clock signal, said synchronized display data, and said synchronized control signal, and outputting said enhanced clock signal, said enhanced display data, and said enhanced control signal for use of said another source driver in said next stage.

21. The flat panel display of claim 13, wherein said transmitter includes a plurality of voltage buffers receiving said clock signal, said display data, and said control signal, enhancing said driving ability of said clock signal, said display data, and said control signal, and outputting said enhanced clock signal, said enhanced display data, and said enhanced control signal for use of said another source driver in said next stage.

22. The flat panel display of claim 12, wherein said display panel is a α-Si liquid crystal display panel.

23. The flat panel display of claim 12, wherein said display panel is a low temperature poly-silicon liquid crystal display panel.

24. A source driver, receiving a master/slave setting signal, a clock signal, a display data, and a control signal to drive a display panel, comprising:
a receiver for receiving said clock signal, said display data, and said control signal; and
a transmitter, coupled to said receiver, transmitter receiving said master/slave setting signal, said transmitter responsive to said master/slave setting signal operating in one of a master mode and a slave mode; wherein
when said transmitter operates in said master mode, said transmitter enhances a driving ability of said clock signal, said display data, and said control signal and outputs said enhanced clock signal, said enhanced display data, and said enhanced control signal for use of another source driver in a next stage; when said transmitter operates in said slave mode, said transmitter directly outputs said clock signal, said display data, and said control signal received from said receiver for use of said another source driver in said next stage.

25. The source driver of claim 24, wherein said transmitter is a differential signal transmitter.

26. The source driver of claim 25, wherein said receiver is a differential signal receiver.

27. The source driver of claim 25, wherein said transmitter is a voltage mode differential signal transmitter.

28. The source driver of claim 25, wherein said transmitter is a current mode differential signal transmitter.

29. The source driver of claim 24,wherein said transmitter is a TTL signal transmitter.

30. The source driver of claim 29, wherein said receiver is a TTL signal receiver.

31. The source driver of claim 24, wherein said transmitter includes:
a data synchronization circuit synchronizing said clock signal, said display data, and said control signal received from said receiver; and
a plurality of buffers, coupled to said data synchronization circuit, receiving said synchronized clock signal, said synchronized display data, and said synchronized control signal, enhancing said driving ability of said synchronized clock signal, said synchronized display data, and said synchronized control signal, and outputting said enhanced clock signal, said enhanced display data, and said enhanced control signal for use of said another source driver in said next stage.

32. The source driver of claim 24, wherein said transmitter includes a plurality of voltage buffers receiving said clock signal, said display data, and said control signal, enhancing said driving ability of said clock signal, said display data, and said control signal, and outputting said enhanced clock signal, said enhanced display data, and said enhanced control signal for use of said another source driver in said next stage.

33. The source driver of claim 24, wherein said display panel is a α-Si liquid crystal display panel.

34. The source driver of claim 24, wherein said display panel is a low temperature poly-silicon liquid crystal display panel.

35. A flat panel display, comprising:
a display panel;
a timing controller outputting a clock signal, a display data, and a control signal;
a control circuit outputting a plurality of mater/slave setting signals; and
a plurality of source drivers, said plurality of source drivers being series-connected to be a series structure, said plurality of source drivers being coupled to said display panel, one end of said series structure being coupled to said timing controller, said plurality of source drivers receiving said clock signal, said display data, and said control signal to drive said display panel, each of said plurality of source drivers responsive to a corresponding one of said plurality of mater/slave setting signals determining whether to enhancing a driving ability of said clock signal, said display data, and said control signal, and outputting said enhanced clock signal, said enhanced display data, and said enhanced control signal for use of another source driver in a next stage.

36. The flat panel display of claim 35, wherein each of said plurality of source drivers, comprises:
a receiver for receiving said clock signal, said display data, and said control signal; and
a transmitter, coupled to said receiver, transmitter receiving said master/slave setting signal, said transmitter responsive to said master/slave setting signal operating in one of a master mode and a slave mode; wherein
when said transmitter operates in said master mode, said transmitter enhances said driving ability of said clock signal, said display data, and said control signal and outputs said enhanced clock signal, said enhanced display data, and said enhanced control signal for use of said another source driver in said next stage; when said transmitter operates in said slave mode, said transmitter directly outputs said clock signal, said display data, and said control signal received from said receiver for use of said another source driver in said next stage.

37. The flat panel display of claim 36, wherein said transmitter is a differential signal transmitter.

38. The flat panel display of claim 37, wherein said receiver is a differential signal receiver.

39. The flat panel display of claim 37, wherein said transmitter is a voltage mode differential signal transmitter.

40. The flat panel display of claim 37, wherein said transmitter is a current mode differential signal transmitter.

41. The flat panel display of claim 36, wherein said transmitter is a TTL signal transmitter.

42. The flat panel display of claim 4l, wherein said receiver is a TTL signal receiver.

43. The flat panel display of claim 36, wherein said transmitter includes:
a data synchronization circuit synchronizing said clock signal, said display data, and said control signal received from said receiver; and
a plurality of buffers, coupled to said data synchronization circuit, receiving said synchronized clock signal, said synchronized display data, and said synchronized control signal, enhancing said driving ability of said synchronized clock signal, said synchronized display data, and said synchronized control signal, and outputting said enhanced clock signal, said enhanced display data, and said enhanced control signal for use of said another source driver in said next stage.

44. The flat panel display of claim 36, wherein said transmitter includes a plurality of voltage buffers receiving said clock signal, said display data, and said control signal, enhancing said driving ability of said clock signal, said display data, and said control signal, and outputting said enhanced clock signal, said enhanced display data, and said enhanced control signal for use of said another source driver in said next stage.

45. The flat panel display of claim 35, wherein said display panel is a α-Si liquid crystal display panel.

46. The flat panel display of claim 35, wherein said display panel is a low temperature poly-silicon liquid crystal display panel.
